(19) United States
(12) Patent Application Publication
(10) Pub. No.: US 2003/0222901 A1
(43) Pub. Date: Dec. 4, 2003

(54) uPrime uClient environment

(76) Inventors: Todd Houck, League City, TX (US); John A. Alden, League City, TX (US)

Correspondence Address: Todd Houck, PO Box 81, League City, TX, 77573, US

(21) Appl. No.: 10/155,176

(22) Filed: May 28, 2002

(51) Int. Cl. G09G 5/00

(52) U.S. Cl. 345/738

(57) ABSTRACT

uPrime uClient Environment is the browser extension of the uPrime Internet Operating System and is the user interface framework that enables primitive display elements of hypermedia pages with enhanced functionality that presents dynamic and interactive information scenes, organizes primitive elements into complex structures, provides interactivity with the user, sends and receives data and data changes to a host(s) or local computer, selectively pauses or prevents information display for delayed processing and selectively prevents or arranges information for hiding or display. Typical interface framework presentation is performed in HTML 4.0 compatible or equivalent browsers; however, this technology is directly applicable to any presentation medium that allows programmatic control of elements in a known relational, contextual, spatial or temporal coordinate system. uPrime uClient Architecture defines a framework that presents information to a user in an interactive, contextual, secure and hidden way. Normally during a uPrime uClient session, such as viewing a web page, the user engages the interface to retrieve or send data to the host server, perform some useful data processing and review or manipulate the published content. The user interface framework provides structure, functionality and input/output with the content host. The host server that the uPrime Client Environment is stored on can be a typical web server or the software can be stored and run from the local computer. uPrime uClient Environment is the new technology and user process that enhances the normal operation and properties of primitive elements of hypermedia documents and other digital formats to facilitate an interactive information environment. The framework translates hypermedia browser elements, public functions, attributes and events into structured information and then modifies the display accordingly. The interface relies on the user interaction and event processing with primitive elements to function. Browser elements may include Hyper Text Markup Language (<TABLE>, <DIV> et cetera), Audio, Video and Multimedia (HDF, HDTV, MPx, AVI, WAV et cetera), Images (JPG™, GIF™, et cetera), applets, objects, programs and other identifiable components. Framework programs are delivered either wholly or in combinations of compiled or interpreted ActiveX™, COM™, Java™, VBScript™, Jscript™ and JavaScript™.

### TABLE OF CONTENTS

1. CITED PATENTS OF RELATED APPLICATIONS

2. COPYRIGHT NOTICE AND AUTHORIZATION

3. BRIEF DESCRIPTION OF THE DRAWINGS

4. TECHNICAL FIELD OF THE INVENTION

5. BACKGROUND OF THE INVENTION

6. SUMMARY OF THE INVENTION

7. DESCRIPTION OF INVENTION

8. DETAILED DESCRIPTION OF THE PREFERRED EMBODIMENTS

9. Claims

10. ABSTRACT

11. APPENDIX

### CITED PATENTS OF RELATED APPLICATIONS

The uPrime uClient Environment, disclosed in this text, is original and useful software. uPrime uClient Environment in no way encroaches upon, does not copy from nor reproduce any other form of prior art. In support of the uPrime uClient Environment claims (Section 9) as being original art, the following cited United States patents referenced are known to be of similar field and technology.

U.S. Pat. Nos. 3,973,245, 3,987,685, 4,148,014, 4,245,244, 4,360,831, 4,369,439, 4,414,628, 4,450,442, 4,555,775, 4,622,545, 4,686,522, 4,698,625, 4,725,829, 4,729,098, 4,752,889, 4,752,908, 4,788,538, 4,803,474, 4,807,158, 4,813,013, 4,847,605, 4,847,788, 4,868,765, 4,896,291, 4,905,163, 4,914,568, 4,931,783, 4,982,343, 4,982,344, 5,021,976, 5,021,989, 5,048,103, 5,050,105, 5,060,135, 5,062,060, 5,065,145, 5,113,341, 5,140,521, 5,140,677, 5,157,384, 5,179,655, 5,186,629, 5,196,838, 5,206,951, 5,250,929, 5,261,041, 5,276,797, 5,283,560, 5,287,446, 5,287,502, 5,291,587, 5,295,243, 5,295,244, 5,297,253, 5,298,890, 5,301,301, 5,301,336, 5,303,337, 5,313,229, 5,315,313, 5,315,703, 5,335,320, 5,339,433, 5,341,466, 5,355,472, 5,359,703, 5,361,350, 5,367,633, 5,371,846, 5,374,942, 5,375,199, 5,386,507, 5,398,044, 5,398,313, 5,404,488, 5,404,506, 5,408,655, 5,408,659, 5,412,770, 5,412,880, 5,414,801, 5,414,809, 5,421,008, 5,421,009, 5,425,139, 5,426,747, 5,428,737, 5,428,776, 5,428,792, 5,430,835, 5,430,839, 5,432,897, 5,432,903, 5,432,932, 5,436,639, 5,440,744, 5,442,791, 5,446,891, 5,446,896, 5,452,414, 5,452,447, 5,457,797, 5,461,710, 5,463,722, 5,471,571, 5,473,344, 5,473,363, 5,473,744, 5,473,772, 5,475,836, 5,481,659, 5,481,666, 5,481,721, 5,481,740, 5,482,051, 5,483,596, 5,485,617, 5,487,141, 5,490,239, 5,491,477, 5,491,779, 5,491,800, 5,491,820, 5,491,821, 5,493,671, 5,497,452, 5,497,491, 5,499,330, 5,499,343, 5,500,935, 5,504,675, 5,504,906, 5,506,951, 5,506,984, 5,506,985, 5,509,114, 5,511,197, 5,515,490, 5,515,491, 5,515,508, 5,517,645, 5,517,663, 5,519,875, 5,524,193, 5,526,480, 5,528,260, 5,528,735, 5,530,455, 5,530,852, 5,532,715, 5,535,325, 5,535,386, 5,537,524, 5,537,526, 5,538,171, 5,541,991, 5,544,302, 5,544,320, 5,546,517, 5,546,529, 5,548,694, 5,548,726, 5,548,779, 5,550,562, 5,550,563, 5,550,969, 5,551,035, 5,551,701, 5,553,223, 5,553,225, 5,553,227, 5,555,017, 5,555,354, 5,555,370, 5,555,427, 5,557,719, 5,557,722, 5,557,793, 5,557,798, 5,559,942, 5,559,958, 5,560,012, 5,560,014, 5,561,769, 5,561,803, 5,562,572, 5,564,051, 5,565,887, 5,565,888, 5,566,302, 5,568,639, 5,570,111, 5,572,643, 5,572,648, 5,572,651, 5,574,918, 5,577,244, 5,577,251, 5,579,464, 5,581,478, 5,581,670, 5,581,758, 5,581,761, 5,584,035, 5,586,311, 5,586,314, 5,586,326, 5,587,902, 5,587,937, 5,588,097, 5,588,139, 5,590,265, 5,590,281, 5,590,362, 5,596,347, 5,602,564, 5,603,025, 5,606,493, 5,608,850, 5,608,907, 5,623,589, 5,623,656, 5,623,679, 5,625,576, 5,625,781, 5,627,979, 5,630,042, 5,630,066, 5,640,501, 5,640,558, 5,640,564, 5,640,566, 5,640,577, 5,642,511, 5,644,764, 5,646,992, 5,649,186, 5,649,190, 5,649,192, 5,649,218, 5,652,880, 5,659,729, 5,664,177, 5,666,138, 5,668,962, 5,668,997, 5,671,416, 5,675,721, 5,675,746, 5,675,752, 5,675,803, 5,675,805, 5,678,015, 5,680,561, 5,680,562, 5,680,617, 5,684,943, 5,689,628, 5,689,666, 5,692,180, 5,710,896, 5,715,416, 5,727,175, 5,732,270, 5,732,271, 5,739,811, 5,742,768, 5,742,813, 5,745,715, 5,758,361, 5,761,511, 5,761,656, 5,761,673, 5,767,852, 5,768,122, 5,768,510, 5,768,578, 5,778,377, 5,784,061, 5,786,818, 5,787,254, 5,790,116, 5,793,382, 5,798,752, 5,802,530, 5,808,601, 5,822,587, 5,838,326, 5,838,965, 5,838,973, 5,842,020, 5,844,392, 5,845,075, 5,847,709, 5,859,934, 5,861,889, 5,867,163, 5,870,549, 5,877,748, 5,877,766, 5,877,767, 5,884,029, 5,884,056, 5,887,139, 5,889,670, 5,889,951, 5,890,137, 5,892,511, 5,897,636, 5,899,990, 5,933,841, 5,940,834, 5,952,796, 5,956,038, 5,956,709, 5,960,411, 5,963,949, 5,974,441, 5,978,582, 5,978,834, 5,982,372, 5,983,190, 5,983,234, 5,986,654, 6,020,885, 6,028,593, 6,049,805, 6,052,717, 6,053,951, 6,058,397, 6,061,061, 6,061,064, 6,061,516, 6,072,466, 6,075,537, 6,078,308, 6,084,587, 6,088,707, 6,091,893, 6,098,081, 6,111,577, 6,112,242, 6,115,712, 6,121,981, 6,122,632, 6,122,657, 6,125,385, 6,125,388, 6,141,018, 6,144,375, 6,144,381, 6,148,304, 6,154,213, 6,154,843, 6,157,936, 6,161,112, 6,161,126, 6,161,132, 6,161,137, 6,163,781, 6,163,822, 6,167,448, 6,167,523, 6,170,007, 6,173,327, 6,175,877, 6,175,954

### COPYRIGHT NOTICE AND AUTHORIZATION

This patent document contains material subject to copyright protection.

uPrime uClient Environment—(C) Copyright Todd Houck and John A. Alden of TheSoftwareWizards.com 1999, 2000, 2001, 2002 (Unpublished). uPrime Internet Operating System—(C) Copyright Todd Houck 1994, 1995, 1996, 1997, 1998, 1999, 2000, 2001, 2002 (Unpublished). All rights reserved. With respect to this material which is subject to copyright protection, the owners, Todd Houck and John A. Alden, have no objection to the facsimile reproduction by any one of the patent disclosure, as it appears in the Patent and Trademark Office patent files or records of any country, but otherwise reserves all rights whatsoever. Power to be Recognized™ is a trademark of Y3K2 and Premiere Media Group.

DOCUMENTUM is a trademark of Documentum, Inc.

COM, VBScript, JScript and WebTV, Windows, Internet Explorer, SNA are trademarks of Microsoft Corporation

O Opera Software is a trademark of Opera Software Corporation, Norway

AOL is a trademark of America Online, Inc.

Netscape is a registered trademark of Netscape Communications Corporation

Java and JavaScript are trademarks of Sun Microsystems

Flash is a trademark of Macromedia, Inc.

Linux is a trademark of Linus Torvalds

Cray is a trademark of Cray Inc.

### BRIEF DESCRIPTION OF THE DRAWINGS AND ATTACHMENTS

FIG. 1 is an Illustration of the uPrime uClient Environment: Flowchart

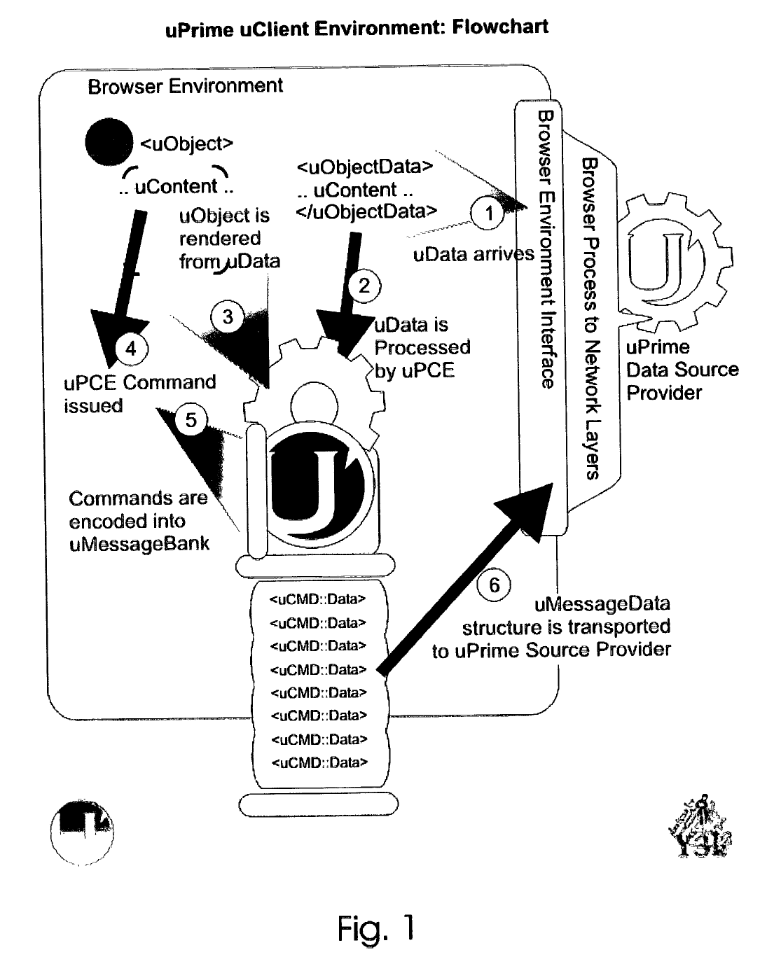

<See File uPrime.uClient.Patent.Application.Illustration.1.Graphics.01.01.jpg>

FIG. 2 is a Screen Shot of InstantMessages.com Demonstration

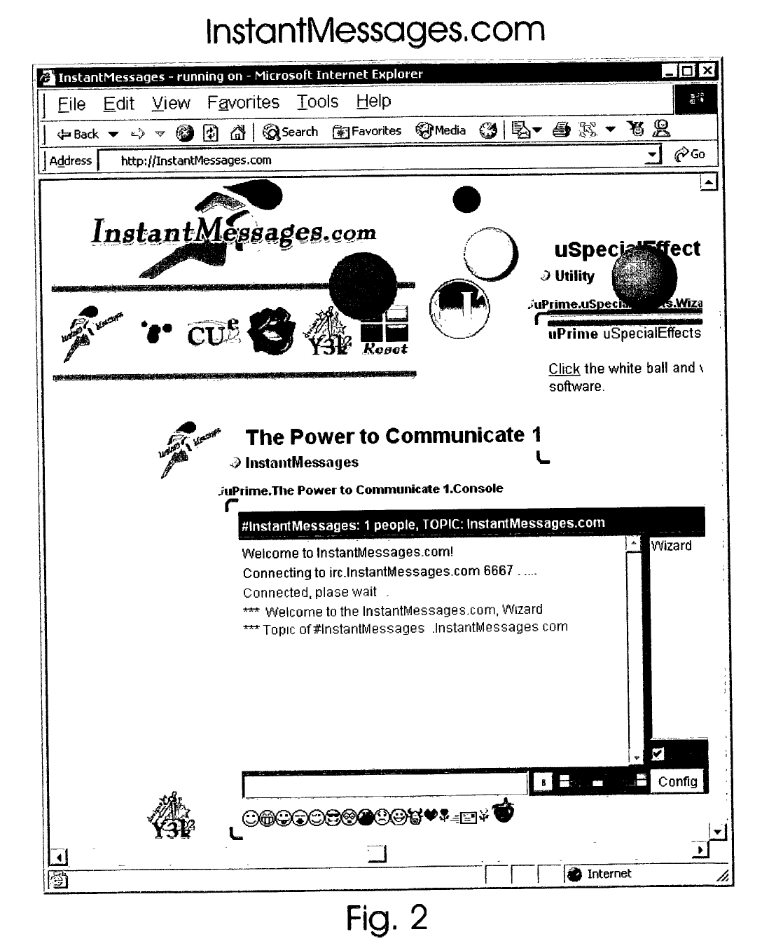

<See File uPrime.uClient.Patent.Application.Illustration.2.Graphics.01.01.jpg>

The CD included herein contains a demonstration of InstantMessages.com based on uClient Technology.

<\InstantMessages.com\Index.html>

The CD included herein contains the APPENDIX 11: Technology details and matter. APPENDIX 11 contains Technology Descriptions and Code to support the claims and Methods of this patent.

<uPrime.uClient.Patent.Application.APPENDIX.TSW.02.13.doc>

### TECHNICAL FIELD OF THE INVENTION

The Invention described herein is used in fields of Software and Communications.

Specifically, uPrime uClient Environment, the browser extension of uPrime Internet Operating System, is a rendering processor. uClient uses a plurality of sources and destinations for acquisition, management and rendering of content data. uPrime Technology applies to environments such as, but not limited to, hypermedia browsers, file and application servers, database connectors, xml and binary stream parsers, web services, Internet, Intranet and Extranet environments, computer desktops and shells, service process areas, media engines and interpreters (such as Audio, Video, Binary, Process to Process communications), embedded devices (Such as robotic controllers, remote control devices), a plurality of sciences, disciplines and industries (Such as Marketing, Communications, Medical Imaging, Inventory, Warehousing and Sales Process, Financial Securities, Modeling, Hosting and Websites, Automotive, Avionic, Aerospace, Nano Technologies and Chemistry, Digital, Analog, Chemical, Optical, Quantum, Atomic and Subatomic Computing, Education and Learning, Food and Recreation, Charity, Religious and Non-commercial Organizations, Physical and Virtual Security and Spatial and Temporal Modeling (CAD)), Manufacturing (CAM), Person to Person (P2P), Business to Business (B2B), Market to Business (M2B) and the availability, presentation, protection and manipulation of public or private data.

### BACKGROUND OF THE INVENTION

uPrime uClient Environment is used in any case where a programmable scene of content and functionality is needed. uClient is largely generic to the kinds of applications that can be built using this invention. In general, it is suited for environments where 10% or more of the information in a scene is repeated on each new request to the source provider for new information (Such as an HTML page in a typical website); where the navigational parts of a scene are similar or identical for a majority of the scenes; where large amounts of intricate functionally needs to be arbitrarily or conditionally compatible and available; where content needs to be hidden, secured or partially rendered; where the process rendering the scene only gets one unique version of a scene; and any case where it makes sense to pull functionality and data into one process for manipulation.

5A. Typical HTML

The remainder of this disclosure will reflect how uClient is used in an HTML compatible browser; specifically Microsoft Internet Explorer™ versions 4.0, 5.0, 5.5 and 6.0. Not all of the current uClient functionality works in the older versions of the browser. Even though this text focuses on Internet Explorer as the Preferred Embodiment, uClient can be utilized in many kinds of browsing environments (Such as Macromedia Flash™, AOL-Netscape Browsers, Opera, Sun Java™ Applets, C++, Basic, PHP, Pascal, SQL, Office Applications, Games, VRML, VLM, AutoCAD HOOPS, MicroStation, 3DStudioMax, and Microsoft DirectX and any compatible environment) uClient code for use by the processor that hosts the scene is largely written In JavaScript to be compatible with C-Like languages. uClient logic can be extended to virtually any system language that provides support for Assignment, Question and Loop logic or equivalent (Such as VBScript™, Visual Basic™, Java™, ActiveX™, PHP and others).

A HTML document (also called a Page, a Scene or a Context) is composed of a serial string of characters. It is possible to have an HTML Page in a browser that never reaches the end of the HTML stream from the source provider. The browsing environment reads an HTML stream from an arbitrary, default or conditional source and loads it into a memory structure that is usually displayed as an organized set of information and images in front of a user. Machine-to-Machine HTML typically uses different kinds of organization than a visual scene, with fewer images perhaps or even whole streams of data that do not end from cameras or audio that might not make sense to a user displayed spatially as binary sequences of data.

The browsing process typically loads data from a new stream for each external HTML reference such as objects, components, applets, scripts, images, sounds and other framed HTML documents. All of these things are independent of uPrime Technology. Furthermore, uPrime exists as software comprised of Dynamic HTML rules, functions, programs and content in an HTML browser and generally exists as a collection of functions and structured data compatible with the environment hosting the scene. uClient functionally may exist in a browser environment as encrypted, binary, comments or raw formats that are themselves contained in basic hypermedia elements and are incomprehensible to the user or processor.

5B. Dynamic HTML and Style Sheets

HTML 3.x specification enabled the industry to compose document collections (websites) with navigational abilities that were rich with content, color and graphics. Browsers generally have the ability to resolve links to specific locations, post forms and draw arbitrary content in arbitrary arrangements. The HTML 4.0 specification introduced a number of features that creates what the industry calls “Dynamic HTML” when combined with the standard functionality of HTML 3.x “Dynamic HTML” is HTML that can be scripted with a programming language. uClient uses Dynamic HTML in a HTML 4.0 browser or equivalent to manipulate structured and unstructured data.

HTML 4.0 also introduced the concept of Cascading Style Sheets (CSS). CSS is used to assign graphical formatting like fonts, coloring and decoration to an HTML element. CSS is important because it allows the programmer to build the styles into a logical theme for assigning to the greater content. This method of formatting hypermedia is superior to inline formatting because CSS reduces formatting redundancy; localizes the definitions of format styles to a central place and is easily rendered conditionally based on the requirements of the browsing environment. uClient uses CSS to format rendered content.

Microsoft Internet Explorer™ versions 4.x, 5.x and 6.x allow hypermedia elements to be assigned arbitrary dynamic properties. These properties are syntactically equivalent to the properties defined in HTML proper and are used to store arbitrary values that pertain to a HTML element. uClient utilizes this feature with some of the content elements. Other environments offer similarly compatible methods of assigning arbitrary properties and data to identifiable environment objects and structures. (Such as Macromedia Flash™, AOL-Netscape Browsers, Opera, Sun Java™ Applets, C++, Basic, PHP, Delphi, SQL, Office Applications, Games, Virtual Reality Modeling, VLM, AutoDesk AutoCAD HOOPS™, MicroStation™, 3DStudioMax™, Microsoft DirectX™, VBScript™, Visual Basic™, Java™, ActiveX™, PHP and any environments that offers similarly compatible methods of assigning arbitrary properties and data to identifiable environment objects and structures and that allow programmatic manipulation of the object, structures and properties).

5C. Page After Page After Page

The real problem facing the universal infrastructure of hypermedia distribution is the acquisition of multiple streams from a source provider. The page and each reference to an external data source (Such as images, scripts, applets, objects, sounds and video) must be requested and delivered with multiple client-provider communication transactions to fully acquire a whole page (or scene). Some browsers recognize images and files that have been called before and “cache” them on the local host computer by storing them in temporary location that is identifiable and relevant to the source of the data streams. Caching files in this manner utilizes local storage space and can become stale such that the local data is out of date relative to the current source data. uPrime IOS and uClient solves this by reducing the number of redundant data requests to multiple sources to one (1) each in most cases. The combination of uClient Technology and generic browser caching provides a superior scenic experience for the user and minimizes bandwidth requirements for process-to-process, user-to-user, user-to-machine and machine-to-machine transactions by design.

5D. Broad Compatibly Problems of Managing Information over Time

Unless a page is rendered from a process, a page of HTML is dated as soon as it is saved to disk. Browsers may support feature enhancements over time, but the binary data sequences that make up the text of the hypermedia documents do not change unless they are edited. This is a problem for every reason that changing the information or formatting is needed. uPrime IOS approaches data management differently than the traditional website content structure ideologies. uPrime IOS stores information in an abstracted state of being. uPrime IOS and uClient processes morph the abstracted data structures into structures that are compatible the destination browsing environment. Data stored with uPrime Techniques can be visually and functionality enhanced over Time without necessarily altering the underlying data sequences, styles and functions. This is starkly different to object-code rendering environments (Such as Java™) because at each level the basic structure and content data sequences remain very similar or exactly like the original source data. uPrime data structures and content are abstracted to be easily identified and morphed from one state of rendering to another by design.

5E. Inconsistent Organizing of Elements with Infinite Possibilities: Non-Standard Presentation

Very few websites look like any other website. This means going to each one is a learning experience for the user. The effect is one of the reasons why 90% of the Internet web traffic happens on less than 100 of the available websites. People become comfortable with a source provider by learning how to use the provider navigation controls and returning over and over. Some processes are spawned by events attached to generally accepted identifiers (Such as the “Home” Button on a website, a “Square” with an “X” in the middle, Arrow, Hand and Text cursor shapes). uPrime Technology enhances scene cachet by uniformly rendering scenic representations of arbitrary content. The uClient renders arbitrary uObject and included content with useful properties like the ability to Open and Close, change position and visibility, rollover pixel changes and color coded identifiers that otherwise would not exist. This trait is useful to Users because of the vast amount of content that can be manipulated similarly and is useful to the Provider because content development can be focused on actual content instead of navigation and coordination of supporting content.

### SUMMARY OF THE INVENTION

::uPrime solves all these problems.

The uPrime uClient Environment invention solves afore mentioned problems in a new and useful way. uClient objective is to render and maintain abstracted provider resources into an information presentation known as a scene (also known as a Page, a Context or a Display). uClient is used to enhance hypermedia elements existence by the addition of proprietary technology disclosed in this text. uClient is platform neutral and is comprised of the basic functionality of a hypermedia environment and regular hypermedia elements.

### DESCRIPTION OF INVENTION

7A. Overview

uPrime uClient Environment is useful for translating data communications in and out of hypermedia browser environments. Effects and functionality of the uClient can be seen through applications that are built using uClient data structures and methods. uClient is not a visible component of the browsing environment.

7B. Presentation Basics

Hypermedia software or hardware browsers request streams of binary data from source providers (Such as a website, a file system or any kind of process request that results in a stream of data). The browser interprets the content of the response to the request and typically arranges the response in a memory structure that is in turn rendered by the browser to the area of a computer screen that is associated with the requestor process. The browser recognizes links to additional sources of data streams and loads them into memory as well. The browser typically makes the structured content and the external elements available to the software functions on the page by using a standard memory access model (Microsoft Document Object Model™ (DOM) in this illustration.) and related Application Programmers Interface (API). The remaining portions of the hypermedia content and external data arrive and are inserted into the memory model and are typically represented on the visible screen assigned to the process.

Once all of the data has arrived typical browsers initiate an “onload” event that the software in the scene can use to spawn additional processing. The “onload” event means that all of the hypermedia has been loaded into memory. uClient initialization can occur as a result of the “onload” event handler software, actuated from inline software, and as the result of software that handles an arbitrary user event (Such as clicking a button or user authentication logic). uClient searches for compatible data structures and renders each one into a morphed representation in the browser memory model. This process usually results in the display (or actuation) of content on the visible page. uClient structured data may be fully rendered and hidden from view and hidden from the generic memory model by design.

uClient content is rendered in standard hypermedia syntax such that it is compatible with the browser environment. Rendered content may request additional augmentation from the uClient based on user events, timers and processing conditions. uClient performs management on rendered content such as search, open, close, coalescence, transformations, positional and orientation changes, hide and display. The basic functionality of the uClient and the browser environment is used by the application to perform useful services to users and machines.

7C. Pronunciation and Naming Conventions

The pronunciation of “uPrime” is “You Prime”; other words with preceding “u” identifiers related to the uPrime Operating System like “uClient” and “uobject” are pronounced simply “Client” and “Object” with a silent “u”. The “u” is always spoken for specific references to uPrime Technology in comparison with other technologies using ambiguous words. The “u” is always written explicitly in documentation. uPrime nomenclature and syntax is largely created with a preceding “u”, “UPR” or “UPRIME” in the type description portion of a funciton definition (Such as UPRIMEAsk, UPRMouseMove, jsuPopGUID, uSplit, uCommandInterface). uPrime uClient Environment is abbreviated as “uClient”. uPrime Internet Operating System and all the extensions are collectively referred to as “uPrime”, “uPrime IOS”, “uPrime Proper” and “U′”.

7D. Data Encapsulation

uPrime Data Structures are represented syntactically and with relevant structural placement with in the content boundaries of the data environment (Additional content containers can be binary, CAD, VLM, SQL, XML, ASCII and Unicode Files, Process Results, Encrypted and anywhere a stream of content can be identified and accessed in a hypermedia environment.). uClient implements one data structure (UPRObject) and one variation of that data structure (UPRIcon).

<See APPENDIX 11A.5: TECHNOLOGY>

### DETAILED DESCRIPTION OF THE PREFERRED EMBODIMENTS

Process Over View

uPrime uClient Environment is embodied in the context of a software browsing process. uClient uses browser native structures, functions and events to create a complex data rendering engine and communication transport. Initialization and actuation can occur from a plurality of methods depending on the intent of the application. uClient, in most cases, is a passive framework lending advanced functionality to typical hypermedia content.

8A. Process

Referring to Illustration 1 <See File: uPrime.uClient.Patent.Application.Illustration.1.Graphics.01.01.jpg>, (IL1.1) uObjectData arrives from a variety of sources (Such as included with initial hypermedia stream, sent or requested from a provider source, inserted in the context from a compiled applet or object, or any method that makes identifiable structured data available to the browsing process.). uClient uData is complex data that conforms to the uObject (or uIcon) structure template <See APPENDIX 11A.5.a: UPR Data> and is compatible with the target syntax of the hypermedia browser.

(IL1.2) uObjectData is processed by uClient when UPRLoadObjects( ) function is actuated from the browser process by initialization of some any other event that causes the function to be processed. UPRLoadObjects( ) function scans the available pool of data structures. If a compatible data structure is found, the top most hypermedia element is passed to the uCreateDefaultObject( ) function or equivalent function and any equivalent functions may actuate the uCreateDefaultObject( ) function to carry out any default processing for the uClient.

uCreateDefaultObject( ) function examines the uData structure. uObject is rendered from uData by translating received properties into rendered properties and applying them to the uObject being created. Once all of the uData structure has been processed by the uCreateDefaultObject( ) function, (IL1.3)

uClient inserts the rendered uObject Data into the browser content. The browser displays the hypermedia as it would any hypermedia on the page. The occurs over and over each Time new data is requested and the UPRLoadObjects( ) is actuated.

<See File: uPrime.uClient.Patent.Application.Illustration.2.Graphics.01.01.jpg> The rendered uObject structure is composed of Dynamic HTML at this point and does not require any further action from the uClient to be meaningful content. The uObject, and any hypermedia element that spawns events, may invoke additional support functions from the uClient for hiding and display, motion, close, coalesce or other application function. The uObject hypermedia content may send a uCommand to the uClient to retrieve more data (or information) from the uPrime Source Provider. (IL1.4) uCommands issued to the uClient conforms to the uPrime Interface Specification <See APPENDIX 11A.4: uPrime Interface>.

(IL1.5) uCommands are encoded into a temporary uMessageBank structure. The mechanics of encoding the uCommand instructions and data can vary widely from implementation to implementation. Each uPrime compatible component must adhere to interfacing rules such that the uCommand can be assembled, passed along, disassembled and invoked with the functions that will carry out the uCommand instructions. UPRIMEAsk, UPRIMESend, UPRIMEOpen, UPRIMEClose all send the request immediately before returning control to the calling method. UPRIMETell stacks commands in order without sending the data to the uPrime Source Provider. UPRIMETell sequences are usually followed with a UPRIMESend command to send the uCommand Data to the uPrime Source Provider.

(IL1.6) uMessageData structure is transported to uPrime Source Provider. The preferred embodiment is transported via HTTP POST to the uPrime Source Provider. Other embodiments may include methods to send data via sockets, Microsoft Win32 PIPE, Microsoft DCOM, a file stream, XML, SQL, telnet or any other means where a sequence of data can be delivered to another process. One such embodiment enables uPrime uObjects to be transported from one browser to another browser in a P2P (Person to Person) configuration using an ActiveX component to handle the processing and sockets as the low level transport.

8B. Usefulness of Naming and Data Encapsulation Approach

uPrime uClient Environment is a superior rendering framework in part because of the data encapsulation techniques disclosed. The uObject Data Structure is a container for uIcons and uObjectElements that are rendered into separate identifiable components of the larger uObject. Each uObjectElement is also a container for the corresponding hypermedia content included with it or added from application-defined functions <See APPENDIX 11A.5.a: UPR Data>. The practical utility of the uPrime uClient in this regard is to arrange hypermedia scenes and facilitate advanced functionality with a minimal amount of development.

8C. Generic Communication Intent of uPrime IOS

uPrime Internet Operating System communicates with other processes by transmitting structured command-response sequences containing commands and data. Data Encapsulation is achieved by wrapping the content in uObject and uIcon containers <See APPENDIX 11A.5.a: UPR Data>. Container structures are constructed with basic hypermedia elements that conform to the browser environment. Containers are usually invisible and can be displayed, positioned, colored, segmented and manipulated with uPrime uClient Environment or standard hypermedia methods.

8D. Human-Machine Way of Manipulating uPrime Data

Events are browser spawned instruction cycles that are carried out by the corresponding event handler software. uPrime uClient Environment translates and processes human and automated events in a browser environment with a multitude of languages and technologies. The initialization sequence gets the User Interface ready for people and processes to use. uClient processes user commands with logic that translates browser events into feedback response. Most uClient functions are relative to the uObject that evoked the action. Transformations upon the individual hypermedia elements are performed using standard methods exposed by the hypermedia environment.

8E. Detection and Input

uPrime uClient Environment contains initialization code that is included within a hypermedia stream to a browser. An arbitrary event or condition causes an initialization function located in that code to execute. The initialization function may open a communication stream with a source provider. Some or all of the uClient may be included with the initial hypermedia file such that no further communication with the source provider is necessary <See InstantMessages.com Demonstration>. uClient scans the content portion of the hypermedia browser for compatible data structures by calling the UPRLoadObjects( ) function. If uClient finds any compatible data structures, they are included in the input parameter of a relevant uObject constructor function. uPrime IOS includes a general function for this purpose called uCreateDefaultObject( ). This function and others can be easily re-written to include support for application-defined types that extend the core system by design.

8F. Package

uCreateDefaultObject( ) function reads the data and parameter information of the uObject that is passed from the UPRLoadObjects( ) function. If the data structure is compatible, the uClient re-writes (renders) the data structure so that it is compatible with the browser environment. The new data structure is inserted into the browser content once it is completely encoded. The original data the rendered uObject is created from is then discarded. End to End, uPrime Data is enclosed in hypermedia compatible structures and follow environment rules of operations such that the desired outcome is achieved.

8G. Operations

uPrime Internet Operating System and the uPrime uClient Environment is based on very simple data structures and methods. The purpose for the limited number of data types and interface functions is to make software development easy for the developer thereby reducing labor and resource costs. Even so, the scenes are capable of advanced functionality with application software that uses uPrime Technology as a basic tool. Application software is capable of writing in a plurality of circumstances with combinations of data and method availability and may be securely hidden from the context.

<See APPENDIX 11A: Technology>

8H. Interactivity

uPrime uClient Environment standard operations provide a rich potential for interacting with a user or process. uPrime Technology is fully capable of delivering none, all or partial scenes based on the circumstances of the application. Unmodified uObjects can open, close, minimize, arrange, move and include complex hypermedia and further application defined instructions. uObjects can be distributed to a plurality of calling contexts such that multiuse content and functionality is readily achieved. uPrime interactivity is based on encoding binary data into compatible character strings, passed as parameters and can be implemented in most compiled, partially-compiled, component or interpreted languages.

8I. Output

The Output of the uPrime uClient Environment is native content and conforms to the rules and syntax of the browser environment. Some of the hypermedia that makes up uObject data structures is embedded with additional functionality and styles to interact and perform function calls into the uClient. Output elements may include CSS styles and hypermedia attributes to enhance their characteristics. The user and software can further manipulate the content and arbitrarily engage the uPrime uClient Environment and uPrime Source Providers.

### 8J. CONCLUSION

Thus describing our invention, what we claim as new, and desire to secure by Letters Patent is uPrime uClient Environment. The software that implements the embodiment of the uPrime uClient Environment uses a discrete methodology to facilitate scene mechanics and communications transport to users, processes and uPrime Source Providers. uPrime uClient Environment can be further demonstrated in the accompanying Illustrations, lnstantMessage.com Demo Software and through the Internet at these universal resource addresses:

http://uPrime.com

http://AmericasFavoriteFries.com

http://InstantMessaaes.com/http://InstantMessages.net/http://InstantMessages.org

http://OfficialSiteofSpace.com

http://OfficialSiteofTime.com

http://OfficeofthePresidentoftheunitedStates.com

http://PlanetNano.com

http://RememberTheTowers.org

http://TheSoftwareWizards.com

http://WorldsGreatestEditor.com

http://WorldsGreatestGolfer.com

Thus describing our invention, what we claim as new, and desire to secure by Letters Patent is:

1. Claim for the Method and Process of managing information within a browser, having the value and virtue of:
a. creates unique object oriented data representation and information presentation in hypermedia pages displayed on browsers capable of at least HTML 4.0 methods and properties or equivalent; encapsulates information into discrete identifiable units in order to manipulate unit in part or as a whole; selectively pauses or prevents information display for delayed processing; selectively prevents or arranges information display for hiding said information;
b. enhances information presentation with new and conditional functionality; delivered with initial page data of a user session to a browser; delivered either statically, synchronously or asynchronously wholly or in combinations of program code written in hypermedia languages like VBScript™, Jscript™, JavaScript™, Java™, Active™, COM™ and a variety of suitable syntax types;
c. accesses a software or hardware device that exposes at least one interface based on a known spatial and temporal coordinate system; typical host devices are hypermedia environments capable of at least HTML 4.0 methods and properties or equivalent;
d. creates synthetic environment for element interaction through the availability of state variables and related process functionality; said environment enhances the typical environment to provide additional functionality and delivers a superset of the original capabilities of the typical environment;
e. manages a dynamic plurality of information and media elements; identifies structured information in the browser that are the subjects of management either prior to or at the time of initial page ready state, identifies elements at the time the said elements are to be displayed and/or each time a new element should be created;
f. presents the user with information as discrete, composite and interactive portions of a hypermedia document; confines relative information into identifiable containers to illustrate ownership, hierarchy and context relativity of underlying data; formats information as complex structures of hypermedia primitive types; facilitates user experience with processing of said complex structures;
g. initiates operation via browser generated “onload” event or equivalent; initiates operation via browser element generated “onload” event; initiates operation by direct scripted command to browser in page; initiates operation by direct response to event from user interaction with said page;
h. conditionally sizes surface to n units x by n units y by n units z; conditionally sets virtual origin to n/2 units x by n/2 units y by 0 units z to simulate logical zero x, zero y and zero z; and may define an arbitrary number of higher order dimensions;
i. examines page data that is organized into a known primitive data structure output from the content host with identifiable characteristics loosely referred to as “objects”; dynamically builds data structures that are based on the characteristics of the original page or new content; inserts new element data structures into page through a plurality of build processes; repeats operation until available data primitives have been processed;
j. enables interaction with page elements through the command-response architecture; said interaction creates an interface comprised of structured hypermedia code, scripts, images, applets, content and objects that are both dynamic and plural;
k. receives real or simulated indication of requirement for the change in state from the device(s); real indication can come through ordinary devices; simulated indication can come from other extraneous processes or remote user input;
l. determines subject for change in state from a known group of elements; determines subject for change in state from searching the given elements; determines subject for change in state from an external provider;
m. assigns the state change to the subject causing to the subject to have new attribute values that may cause the subject to move, change color, uncover hidden information, disappear and a variety of additional effects;
n. provides hypermedia compatible form for holding client request prior to posting information to the provider; adds and modifies request cache to change persistent data or perform background operation; provides deletes of requests located in request cache; provides means for encapsulating page state information into provider response; provides means for executing communication transport to send data to provider.

2. Claim for the Method and Process for serving structured information with a browser in having the virtue and value of:
a. creates provider database management and interaction interface; useful for the presentation of contextual information arrangements that become enhanced hypermedia environments;
b. creates structured data for presentation that becomes the composite content data of the context; said composite data can come from database records; said composite data can come from process results; said composite data can come from any readable stream available to the process; said data composite can include or link to static art created prior to or during execution or place holder for future content that is retrieved from a variety of sources;
c. processes input values, if any, from reception of command-request streams; said process may respond with structured data related to the user interaction; said process may require underlying database to Open or Close system objects by loading or unloading them from a context respectively; said process may require the read or write of data to the underlying database; said process may require underlying database to authenticate that two private values are equal;
d. responds to command-request by writing an appropriate header to begin the fulfillment of the request and successive user requests by conditionally writing data structures that represent composite objects that become the subjects of management in the context; conditionally responds to command-requests by writing the structured data that will become the next client command-response transport; responds to command-request by writing the program code that enables the client response transport;
e. reduces user interaction by discretely bringing requested data to the user instead of reloading entire context.

3. The method of claim 1a, wherein display elements are defined as unique identifiable components of the device is accomplished by labeling data structures with human readable and machine-generated names.

4. The method of claim 1a, wherein display elements are selectively paused or prevented from display for future processing; presents display elements in a intermediate state partially rendered and included hypermedia or script; and can be manipulated or ignored while in a hidden state.

5. The method of claim 1a, wherein display elements are arranged based on processing values and conditionally makes data visually or programmatically available or unavailable for further manipulation by the user or user process.

6. The method of claim 1b, wherein the presentation environment is enhance by the addition of software, content and methods that are collectively the uPrime uClient Environment; is available wholly or in part to the presentation environment and can be used, altered or ignored by the presentation; allows for platform basic services to be generally available; and largely ignores items that are not directly interacting with the uPrime uClient Environment.

7. The method of claim 1b, wherein uClient software and content are delivered statically, synchronously or asynchronously through a plurality or functions and sources based on temporal, spatial and event driven input responses; statically referring to supporting code and content that is delivered with the initial environment for initialization; synchronously referring to supporting code and content that is delivered conditionally per request to the content source; asynchronously referring to supporting code and content that is delivered or created concurrent with other processes and stream communications.

8. The method of claim 1b, wherein functionality is delivered to a browser by piecing together the required components of the uClient and delivering it to the calling process through normal stream techniques; can include unlimited combinations of HTML, Script, XML, Object and Element References and virtually any kind of binary data; and can be delivered wholly or in parts based on the logic of conditional, contextual, spatial, temporal, probabilistic and application defined processing.

9. The method of claim 1b, wherein functionality is provided as combinations of Javascript™, JScript™, VBScript™, ActiveX™, Java™ and COM™ and many other languages and platforms.

10. The method of claim 1c, wherein uPrime uClient Environment utilizes spatial and temporal functions provided by the browser environment to manipulate complex data structures and content.

11. The method of claim 1c, wherein uClient spatial functionality includes the abilities to show or hide content; absolutely position in Cartesian, Angular or Contextual Coordinates based on a 3, 4, 5 or more dimensional environment; and infer or derive multidimensional context state from the properties of local or external content.

12. The method of claim 1c, wherein uClient Temporal functionality may include the ability to provide an ordered sequence of processes, sequential numbering of subsequent content and content derivatives, random numbering over multiple contexts; and functionally derive content based on arbitrary sequential numbers.

13. The method of claim 1d, wherein synthetic environment is constructed with primitive functions, semi-complex data types and content that is partially or fully rendered; can be recreated over and over to suit the needs of multiple concurrent calling processes that require structured information; can be conditionally created so that no two instances of an arbitrary context can be recreated or duplicate previous renditions; can be arbitrarily and remotely rendered on a plurality of output devices for diverse needs such as language, special accessibility, machine to machine processing, store and forward processing, distributed processing and probabilistic processing with an infinite variety of outcomes.

14. The method of claim 1d, wherein synthetic environment enhances browser functionality by adding additional logic and content to basic hypermedia services; uses structured interface, content transport and manipulation routines, content description, enumeration and rendering capabilities; can be leveraged and incorporated with session and application defined software to facilitate the fulfillment of arbitrary requirements; is augmentation that provides a broad range of content and functionality to the browser environment with a relatively small memory size typically equal to about 10% to 20% of the total size of an application.

15. The method of claim 1d, wherein synthetic environment makes state variables available to context logic through combinations of hypermedia, script, XML, Object and Element References and virtually any kind of binary data or object code that can be identified and processed within a browser environment or retrieved from a remote device; uses complex objects that can arbitrarily include and actuate processing, data and properties; searches for processing logic and data to fulfill a request that may include calls or access requests to functionality or data that does not currently exist in the calling process; manipulates content to incorporate or restrict existing functionality and the availability and usability of existing data; presents, modifies and stores state variables and content display with a variety of local, remote, dynamic and static sources.

16. The method of claim le, wherein plurality of information and media elements are created and managed from content provided with the initialization, introduced from an arbitrary stream from local or remote processes and processors; arbitrarily written to remote or local streams, deleted, abandoned, disabled, recreated or instantiated from primitive content and logic; and can be generic browser scripting and data that operates with or without uClient augmentation.

17. The method of claim 1e, wherein identifiable content elements have structured properties and logic that are arbitrarily used and are manipulated or ignored as necessary to facilitate process requirements.

18. The method of claim 1f, wherein information is confined in browser containers and relevant syntax such that the overall context conforms to the running browser environment; is located within the working structure of the browsing environment; and manipulates itself as necessary to facilitate process requirements.

19. The method of claim 1f, wherein information illustrates ownership, hierarchy and contextual relativity by transforming content data in relation to arbitrary affiliations; and illustrates ownership by directly locating content within higher order content containers, general and event color coding, showing or hiding portions of content and the use of actual and symbolic interfacing techniques.

20. The method of claim 1g, wherein “onload” event can be any process that causes the initialization of the uClient Runtime Environment.

21. The method of claim 1h, wherein n is an arbitrarily large number; is usually larger than the visible height and width in a user browser; is always equal or less than the maximum integer value the browser coordinates system can handle.

22. The method of claim 1h, wherein the virtual origins can be single relative points inside any number of other contextual hierarchies that process spatial or temporal properties.

23. The method of claim 1i, wherein data primitives are processed and incorporated within the content can be actuated arbitrarily from a variety of sources through the uClient Interface.

24. The method of claim 1j, wherein command-response architecture is a product of uClient and the stream provider mechanism and underlying interface; may provide full, partial, none, store and forward context sensitive interfaces for manipulation of the content; may request and divert content and logic to arbitrary provider streams; and can convert subsequent streams to arbitrary data types for secure and accurate distribution of data.

25. The method of claim 1k, wherein change results in additional processing and possibly the further manipulation of the content based on the new data or other conditions.

26. The method of claim 1l, wherein determination occurs through combinations of application and uClient Runtime functionality that interpret stated conditions and act upon them; can be the result of an arbitrary request from browser events, intervals and new logic; and can be the result of remote process or user, security or hazard alerts, political or market fluctuations, weather changes, physical phenomena, acts of God or anything that can cause an identifiable state change.

27. The method of claim 1m, wherein assignment is performed by altering the content and properties of the data to reflect the new information; may change individual properties of individual elements, write and overwrite elements, sections, objects or entire contexts; may duplicate subject of assignment either identically or partially; and may delete, discard, abandon or completely change the subject of the assignment.

28. The method of claim 1n, wherein form is a structure for encapsulating commands, assignments and binary data; is sequenced to maintain First-In-First-Out (FIFO) order of instructions; may be chained with subsequent forms for transmitting multi-segmented data streams; and may be delivered by a variety of transport mechanisms including synchronous, asynchronous, file, memory and process streams.

29. The method of claim 1n, wherein request cache refers to sequence of command-requests to the provider; is increased with additional information until conditions exist that actuate a posting operation; and is cleared after a successful posting operation to the source provider.

30. The method of claim 2a, wherein database management is defined as programmatic control of a data processing system through the uses of communication interfaces; and exists synchronously, asynchronously or as needed to communicate with a plurality of provider resources.

31. The method of claim 2a, wherein contextual information arrangements are arbitrary composites of HTML, Script, XML, Object and Element References and virtually any kind of hypermedia; are conditionally assembled, retrieved, disassembled, read and written whole or in part; and may be represented as multi-segmented streams of data that as a whole make up the content structure.

32. The method of claim 2a, wherein enhanced browser environment is any hypermedia software platform that is HTML 4.0 compatible or equivalent; can contain multiple types of media, software, script, code and binary data; and can be interfaced by compiled or interpreted processing components and code of local or external origin.

33. The method of claim 2b, wherein context is an arbitrary collection of hypermedia primitives; uses or creates structured data that is identifiable and contains code, properties and binary information; interacts with stated data definitions and values; and encompasses the uPrime uClient Environment running instance within a given process;

34. The method of claim 2b, wherein multiple sources of content are delivered to the uPrime uClient Environment can be performed by the command-response architecture, browser environment, memory map, local and far function and database calls or any other means for associating data with the given context.

35. The method of claim 2e, wherein interaction reduction occurs because the number of requests from the uPrime uClient Environment for additional resources is reduced.
